(19) United States
(12) Patent Application Publication
(10) Pub. No.: US 2014/0003914 A1
(43) Pub. Date: Jan. 2, 2014

(54) LOCKABLE DRIVE ASSEMBLY FOR ROTATABLE MEMBERS

(71) Applicant: Ali A. Namous, Allentown, PA (US)

(72) Inventor: Ali A. Namous, Allentown, PA (US)

(73) Assignee: Aktiebolaget SKF, Goteborg (SE)

(21) Appl. No.: 13/996,022

(22) PCT Filed: Dec. 14, 2011
(86) PCT No.: PCT/US11/64885

§ 371 Date: Sep. 9, 2013

Related U.S. Application Data
(60) Provisional application No. 61/425,134, filed on Dec. 20, 2010.

(51) Int. Cl. F16D 11/00

(52) U.S. Cl. CPC F16D 11/00
USPC 415/123

(57) ABSTRACT

A lockable drive assembly includes an input member rotatable about the axis and having opposing axial ends and a clutch member fixed relative to the axis. An output member with opposing axial ends is slidably coupled with the driven member such that the output member is displaceable along the axis relative to the driven member and angular displacement of the output member angularly displaces the driven member. The output member is engageable with the clutch member to prevent angular displacement of the output member and has at least one drive surface proximal to an inner end and extending circumferentially and axially about the axis. An input member inner end is engageable with the output member drive surface such that angular displacement of the input member displaces the output member out of engagement with the clutch member and then displaces the output member about the axis to rotate the driven member.

The present invention relates to drive assemblies, and more particularly to drive assemblies for transmitting torque to rotatable members such as rotary actuators.

Drive devices or assemblies for transmitting torque to rotating members are well known. One problem with certain applications of such drive assemblies is that the driven device may be subjected to a force or torque that causes the rotating actuator to be “back-driven” so as to be undesirably moved or opened. A known device for preventing back-driving of a rotary actuator is a “formsprag” clutch. Although a generally effective device for preventing back-driving of rotating devices, formsprag clutches are relatively expensive to produce and include a generally complex assembly of pins, springs and friction bars that could wear and fail, particularly over a prolonged period of use.

### SUMMARY OF THE INVENTION

In one aspect, the present invention is a lockable drive assembly for transmitting torque to a driven member, the driven member being rotatable about a central axis. The drive assembly comprises an input member rotatable about the axis and having inner and outer axial ends and a clutch member fixed with respect to the axis. An output member with inner and outer axial ends and is slidably coupled with the driven member such that the output member is displaceable along the axis relative to the driven member and angular displacement of the output member angularly displaces the driven member. The output member is releasably engageable with the clutch member so as to substantially prevent angular displacement of the output member and has at least one drive surface proximal to the inner end and extending circumferentially and axially with respect to the central axis. The input member inner end is operatively engageable with the output member drive surface such that angular displacement of the input member axially displaces the output member out of engagement with the clutch member and then angularly displaces the output member about the central axis to rotate the driven member.

In another aspect, the present invention is a rotary actuator comprising a ball screw assembly including a screw and a nut, the nut being rotatable about a central axis and the screw being linearly displaceable along the axis. A lockable drive assembly is configure to transmit torque to the nut and includes an input member rotatable about the axis and having inner and outer axial ends. A clutch member is fixed with respect to the axis and an output member with inner and outer axial ends is slidably coupled with the nut such that the output member is displaceable along the axis relative to the nut and angular displacement of the output member angularly displaces the nut. The output member is releasably engageable with the clutch member so as to substantially prevent angular displacement of the output member and has at least one drive surface proximal to the inner end and extending circumferentially and axially with respect to the central axis. The input member inner end is operatively engageable with the output member drive surface such that angular displacement of the input member axially displaces the output member out of engagement with the clutch member and then angularly displaces the output member about the central axis to rotate the nut.

In a further aspect, the present invention is again a lockable drive assembly for transmitting torque to a driven member, the driven member being rotatable about a central axis. The drive assembly comprises a rotatable input member, a static clutch member having a stop surface and an output member. The output member is slidably coupled with the driven member so as to be linearly displaceable along the axis relative to the driven member. The output member has a retention surface engageable with the clutch stop surface so as to substantially prevent angular displacement of the output member and at least one drive surface extending circumferentially and axially. Further, the input member is operatively engageable with the output member drive surface such that angular displacement of the input member axially displaces the output member out of engagement with the friction surface and then angularly displaces the output member about the central axis to angularly displace the driven member.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is an axial cross-sectional view of a lockable drive assembly of the present invention, shown in the application of driving a nut of a ball screw actuator;

FIG. 2 is a broken-away, enlarged view of an upper portion of FIG. 1;

FIGS. 3A and 3B, collectively FIG. 3, are each an enlarged view of a portion of FIG. 2, FIG. 3A showing an output member engaged with a clutch member and FIG. 3B showing the output member disengaged from the clutch member;

FIGS. 4A-4D, collectively FIG. 4, are each a broken-away, axial cross-sectional view through line 4-4 of FIG. 2, each showing a different point in the process of driving the output member with an input member;

FIG. 5 is a perspective view of the input member;

FIG. 6 is an axial cross-sectional view of the input member;

FIG. 7 is a perspective view of the clutch member;

FIG. 8 is an axial cross-sectional view of the clutch member;

FIG. 9 is a perspective view of the output member;

FIG. 10 is an axial cross-sectional view of the output member;

FIG. 11 is an exploded perspective view of an alternative construction of the drive assembly;

FIG. 12 is a partly broken-away, perspective view of the alternative construction drive assembly; and

FIGS. 13A and 13B, collectively FIG. 13, are each an axial cross-sectional view through line 13-13 of FIG. 12, each showing a different point in the process of driving the output member with an input member

### DETAILED DESCRIPTION OF THE INVENTION

Certain terminology is used in the following description for convenience only and is not limiting. The words “inner”, “inwardly” and “outer”, “outwardly” refer to directions toward and away from, respectively, a designated centerline or a geometric center of an element being described, the particular meaning being readily apparent from the context of the description. The word “connected” is intended to include both direct and indirect connections between two members. The terminology includes the words specifically mentioned above, derivatives thereof, and words of similar import.

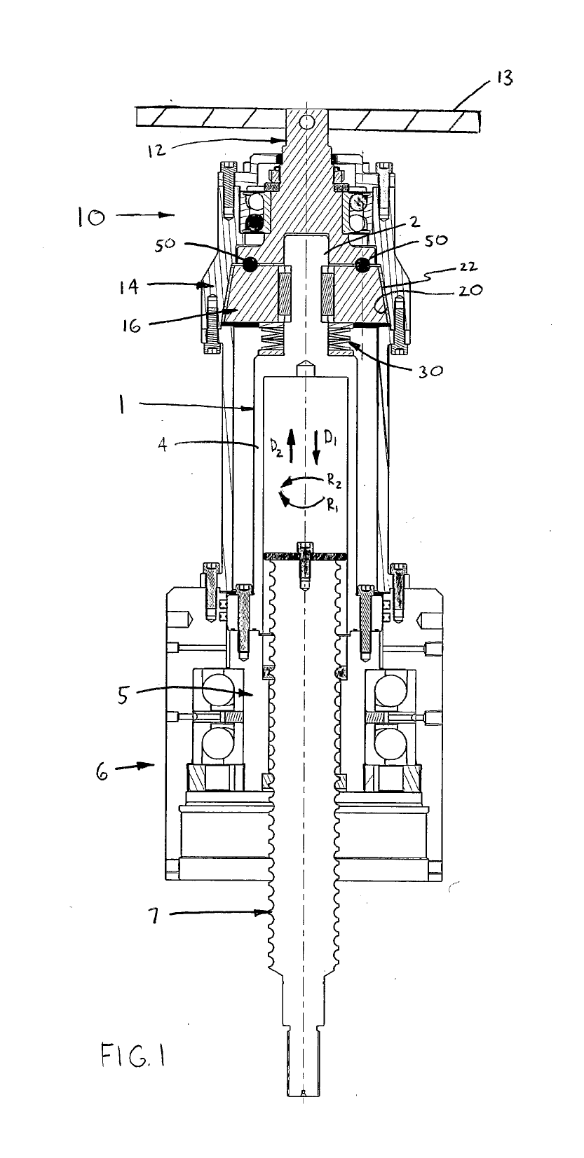

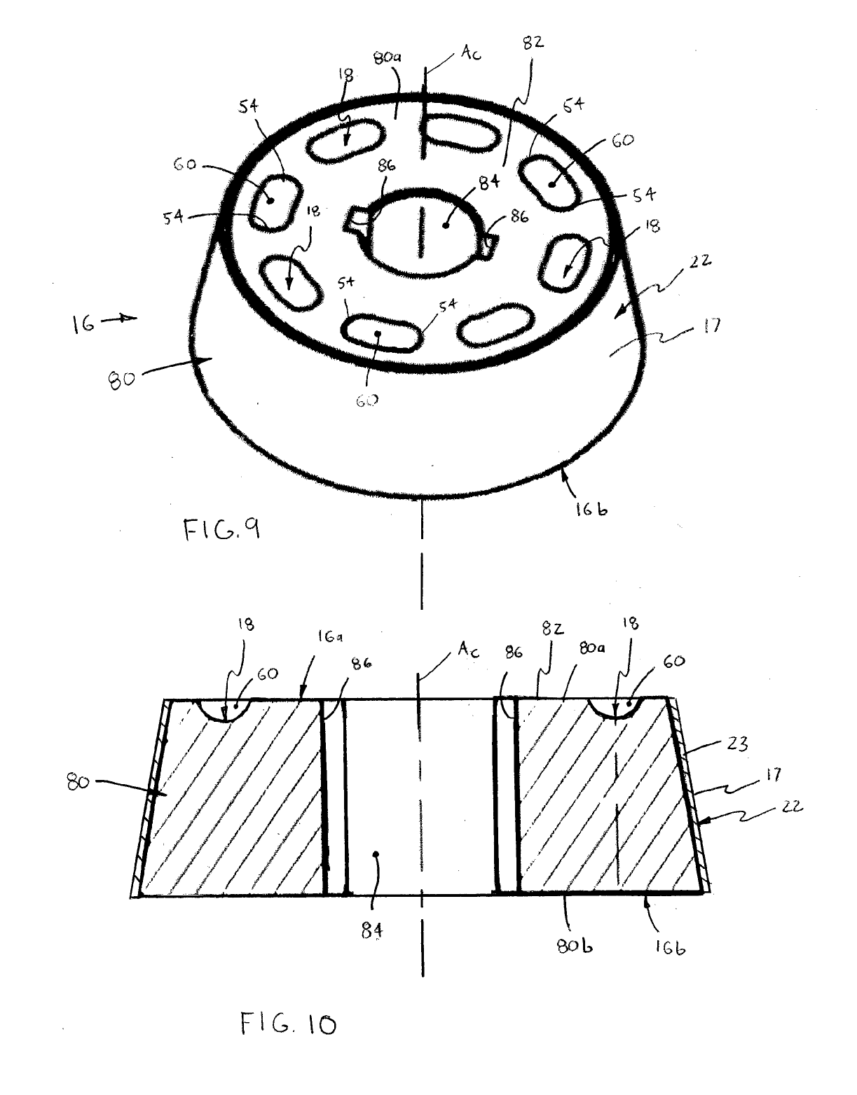

Referring now to the drawings in detail, wherein like numbers are used to indicate like elements throughout, there is shown in FIGS. 1-13 a lockable drive assembly 10 for transmitting a torque to a driven member 1 rotatable about a central axis A_{C}, which in an exemplary embodiment is a connector 4 of a ball screw actuator 6 for operating a gate valve, as discussed below. The drive assembly 10 basically comprises an input member 12 rotatable about the axis A_{C}, a clutch member 14 fixed with respect to the axis A_{C}, and an output member 16 coupled with the driven member 1 and engageable by the input member 12, The input member 12 has inner and outer axial ends 12a, 12b, respectively, the inner end 12 being engageable with the output member 16, as described below, and the outer end 12b being either configured for manual or “automatic” manipulation to rotate the input member 12, and thereby the output and driven members 12, 1, about the axis A_{C}. The clutch member 14 is preferably provided by an integral portion of a generally tubular housing 40, which is sized to at least partially contain the input and output members 12, 16, as described below. Further, the output member 16 has inner and outer axial ends 16a, 16b, respectively, and is slidably coupled with the driven member 1 such that the output member 16 is linearly displaceable along the axis A_{C} relative to the driven member 1, and angular displacement of the output member 16 angularly displaces the driven member 1. The output member 16 is releasably engageable with the clutch member 14 so as to substantially prevent angular displacement of the output member 16.

Furthermore, the output member 16 has at least one and preferably a plurality of drive surfaces 18 each located proximal to the inner end 16a and extending circumferentially and axially with respect to the central axis A_{C}. The input member inner end 12a is operatively engageable with the output member drive surface(s) 18 such that angular displacement of the input member 12 first axially displaces the output member 16 to disengage the output member 16 from the clutch member 14, and then angularly displaces the output member 16 about the central axis A_{C} to rotate the driven member 1. Thus, engagement of the output member 16 with the clutch member 14 prevents angular displacement of the driven member 1 whenever the input member 12 is not being intentionally rotated (i.e., by a user or under actuator control) to drive the driven member 1, thereby preventing “back-driving” of the member 1, as discussed in further detail below.

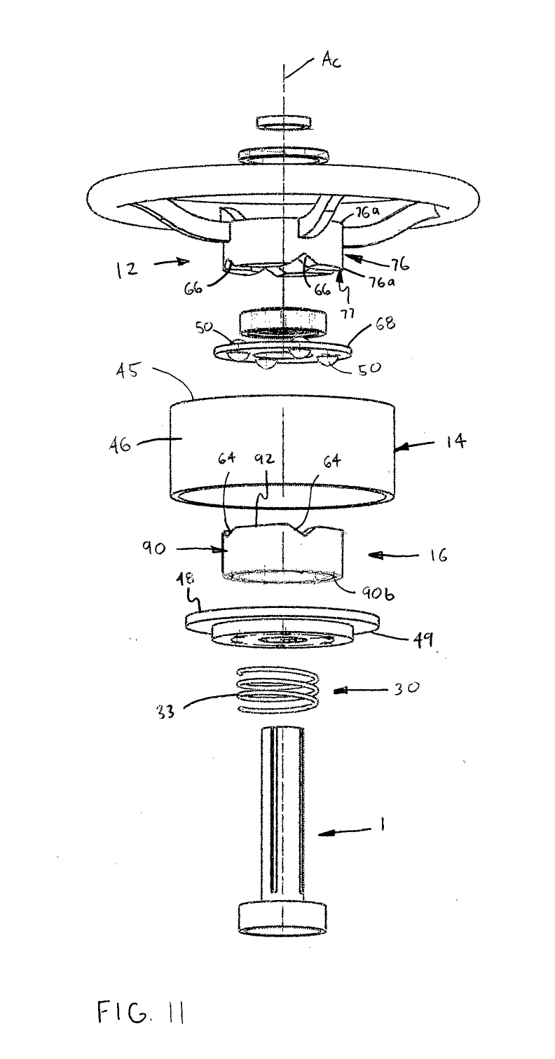

Referring to FIGS. 1-3, the drive assembly 10 preferably further comprises a biasing member 30 configured to bias the output member 16 axially generally toward the clutch member 14 and the input member 12, such that the output member 16 engages with the clutch member 14, and also maintains engagement of the input member 12 with the output member drive surface(s) 24. The biasing member 30 is preferably formed as “stack” 31 of a plurality of spring washers or Belleville springs 32 disposed between a pair of washers 34 located at each end of the spring stack 31. The springs 32 and washers 34 are each disposed about a coupler portion 2 of the driven member 1, one washer 34 being disposed generally against the outer end 16b of the output member 16 and the other washer 34 being disposed against a radial shoulder 3a of a main body portion 3 of the driven member 1, which is axially “fixed” as described below. However, the biasing member 30 may alternatively be provided by one or more coil springs 33, as shown in FIGS. 11 and 12, by a compressible tubular member (e.g., an elastomeric tube), or any other appropriate device capable of biasing the output member 16 generally axially (none shown).

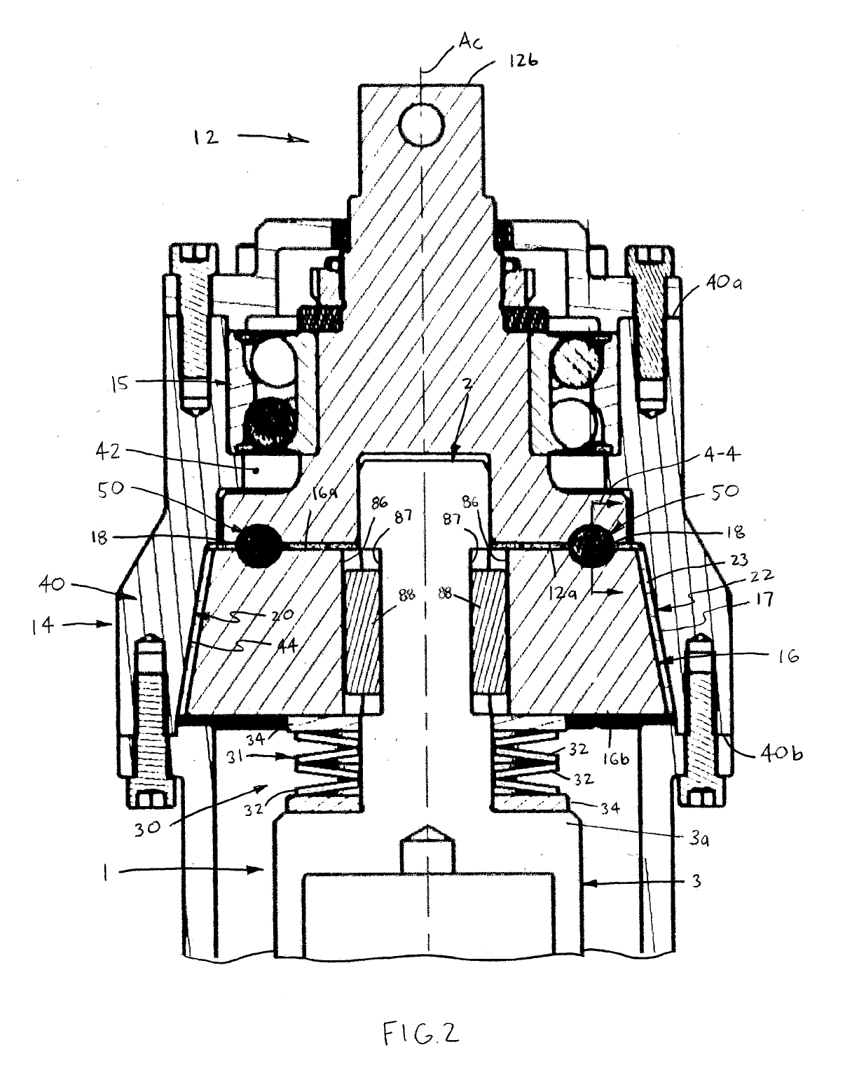

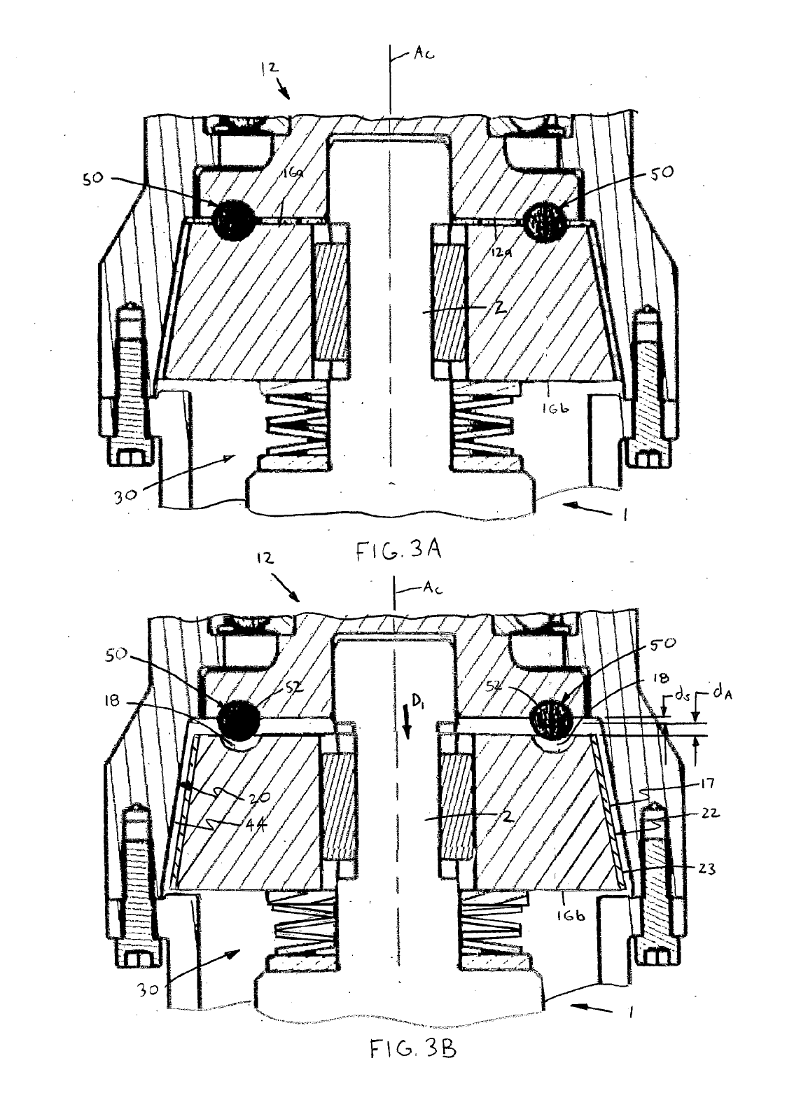

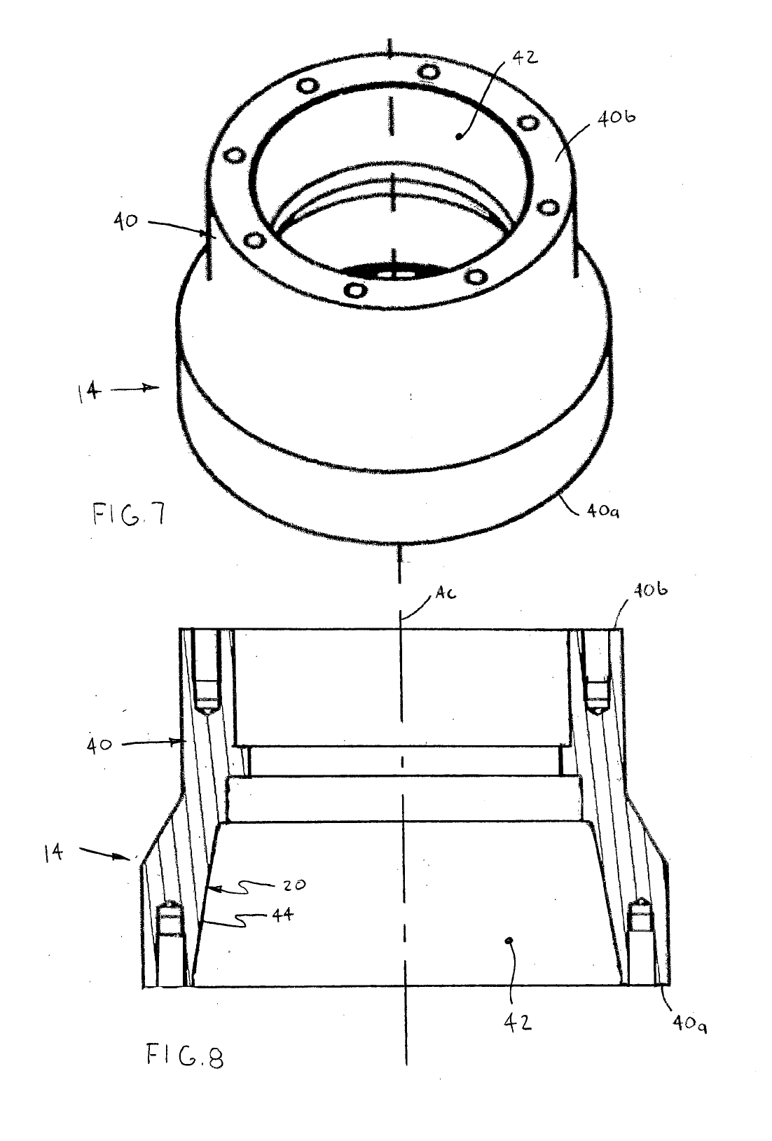

Referring to FIGS. 3, 8 and 12, the clutch member 14 preferably includes a stop surface 20 and the output member 16 includes a mating retention surface 22 frictionally engageable with the clutch stop surface 20. More specifically, as discussed above and depicted in FIGS. 3 and 8, the preferred clutch member 14 is provided by an integral portion of a generally tubular housing 40 having opposing ends 40a, 40b and a central bore 42 extending between the ends 40a, 40b. The input and output members 12, 16 are disposed at least partially within the bore 42 and the clutch stop surface 20 is provided by an inner circumferential surface section 44 at least partially defining the bore 42. Preferably, the inner circumferential surface section 44 tapers axially so as to be generally conical. Further, the output member 16 has an outer circumferential surface 17 tapering axially so as to be generally conical and providing the retention surface 22, the output member 16 being at least partially disposed within the clutch member surface 20 such that the tapering surfaces 20, 22 are engageable or “interlockable” in a wedge-like manner. The preferred biasing member 30, as described above, biases or “pushes” the output member 16 toward the clutch member 14, which forces the mating tapering surfaces 20, 22 together such that angular displacement of the output member 16, and thereby also the driven member 1, is substantially prevented. Further, one of the surfaces 20, 22 is preferably provided by, or coated with, a friction-increasing substance, such as a conventional friction pad 23, as shown mounted about the output member 16.

Alternatively, as depicted in FIGS. 11-13, the clutch member 14 may be provided by a generally disk-like member 45, preferably an integral wall of a tubular member 46, having a surface 47 providing the stop surface 20. In such a construction, the output member 16 has a radial surface 48 providing the retention surface 22 and is engageable axially with the clutch radial surface 47. Preferably, the retention surface 22 is provided by a separate annular member 49 coupled with the output member 16, but may alternatively be provided by an integral portion of the member 16 (not depicted).

Furthermore, although the clutch member 14 and output member 16 preferably have mating friction surfaces 20, 22 to releasably retain the output member 16, the clutch member 14 and/or the output member 16 may be configured to retain the output member 16 in any other appropriate manner. For example, the clutch member 14 may have one or more recesses (none shown) for receiving corresponding projections or lugs (none shown) extending from the output member 16, or vice-versa, such that the coupling of the recesses and projections prevents angular displacement of the output member 16 (structure not shown). Further for example, the clutch 14 and/or the output member 16 may include one or more magnets (none shown) exerting a magnetic force to rotationally fix the output member 16 with respect to the axis A_{C} until a sufficiently high force applied by the input member 12 overcomes the magnetic force.

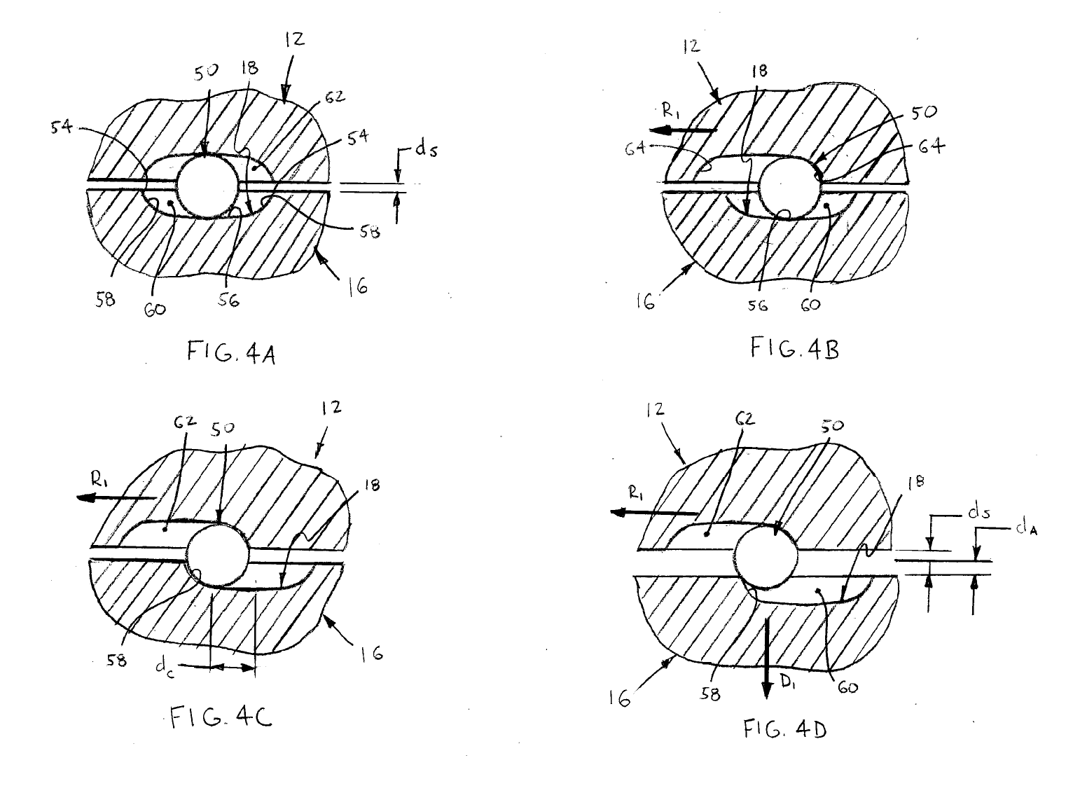

Referring now to FIGS. 1-4, 12 and 13, the drive assembly preferably includes at least one transfer member 50 disposed generally between the input and output members 12, 16 and against the at least one drive surface 18. Most preferably, the output member 16 includes a plurality of the drive surfaces 18 spaced circumferentially about the central axis A_{C} and the drive assembly 10 includes a plurality of the transfer members 50 each disposed against a separate one of the drive surfaces 18. Each transfer member 50 is configured such that angular displacement of the input member 12 pushes the transfer member 50 against the output member drive surface 18, causing the transfer member 50 to displace a circumferential distance d_{C} (see FIG. 4C) along the drive surface 18 until the output member 16 displaces axially a sufficient distance d_{A} to disengage from the clutch member 14. Thereafter, further angular displacement of the input member 12 pushes the output member 16, through the transfer member(s) 50, to angularly displace about the central axis A_{C}. Preferably, each transfer member 50 includes a spherical body 52, so as to be generally formed as a ball, and is rollable and/or slidable along the associated drive surface 18, but may be formed in any other appropriate manner (e.g., as a circular disc, a square lug, etc.).

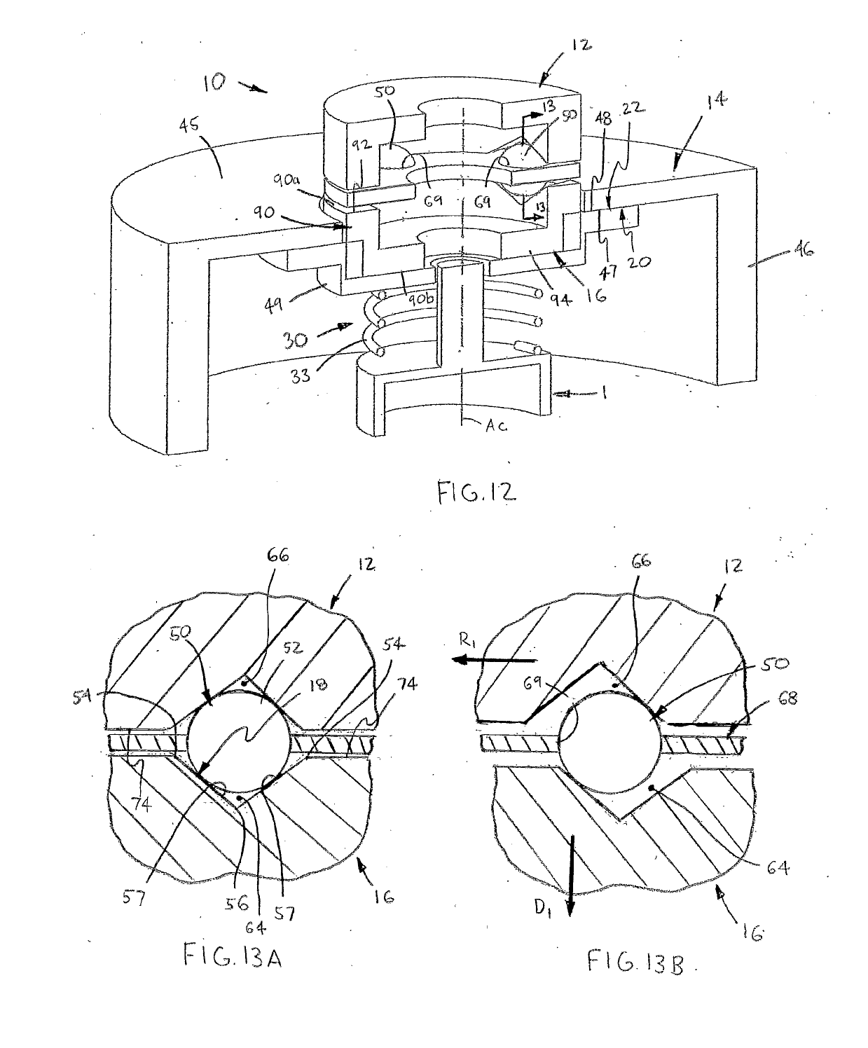

Further, each drive surface 18 has opposing ends 54 located generally at the inner end 16a of the output member 16 and a central section 56 spaced axially from the body inner end 16a. Preferably, each drive surface 18 is formed as a generally continuous surface further having two opposing curved sections 58 each extending between the central section 56 and a separate one of the surface ends 54, as indicated in FIG. 4A. Alternatively, as indicated FIG. 13A, the drive surfaces 18 may each be formed of two generally flat, angled surface sections 57 each extending from a separate one of the surface ends 54 and generally converging at the surface central section 56. In either case, the output member 16 displaces axially when the input member 12 forces the transfer member(s) 50 to displace generally from the drive surface central portion 56 and towards one of the drive surface ends 56, as described in greater detail below.

Although the drive assembly 10 preferably includes one or more transfer members 50 through which the input member 12 rotatably drives the output member 16, the drive assembly 10 may alternatively be constructed without any transfer members. In such an alternative construction, the inner end 12a of the input member 12 is formed to directly drivingly engage with the output member drive surfaces 18. For example, the input member 12 may have one or more projections or teeth (structure not shown) which are directly slidably disposed against the output member drive surface(s) 18. Similarly to the structures having the transfer members 50, the initial rotation of the input member 12 causes the sliding teeth to first push the output member 16 axially out of engagement with the clutch member 14, and then pushes the output member 16 circumferentially to rotate about the axis A_{C}.

Referring now to FIGS. 3, 4, 6 and 8, each of the preferred continuous drive surfaces 18 is preferably provided by a generally elliptical cavity 60 extending axially from a radial end surface 82 of the output member 16, as described below, and partially circumferentially about the central axis A_{C}. The input member 12 preferably includes a radial end surface 74 generally facing and spaced axially from the output member end surface 82 by a spacing distance d_{S} (see FIGS. 3B and 4A) and has at least one and preferably a plurality of cavities 62, each extending axially from the end surface 74 and partially circumferentially about the central axis A_{C}. The input member cavities 62 are spaced apart about the central axis A_{C} and each is generally aligned with a separate one of the output member cavities 60. Further, each one of the transfer members 50 is partially disposed within a separate one of the output member cavities 60, so as to be displaceable along the associated drive surface 18, and simultaneously partially disposed within the aligned input member cavity 62.

Referring to FIG. 4, with the preferred drive assembly construction, the input member 12 drives the output member 16 through the transfer members 50 in the following manner. When the drive assembly 10 is in a static or non-rotational state, each transfer member 50 will preferably be located at the center of the drive surface central section 56, as depicted in FIG. 4A, but may be located toward either end 54. In any case, when the input member 12 begins to rotate, for example in a first angular direction R₁ as shown in FIG. 4, the input member 12 must first angularly displace relative to the output member 16 until an end section 64 of the input member cavity 62 contacts the transfer member 50, as shown in FIG. 4B. The input member 12 then continues to angularly displace relative to the output member 16 while pushing the transfer member 50 to roll or/and slide toward one end 54 of the drive surface 18 within the particular output member cavity 60, as shown in FIG. 4C. As the input member 12 pushes the transfer member 50 to displace along one curved section 58 of the drive surface 18, the output member 16 is pushed axially in a first, outwardly direction D₁ away from the input member 12, which is fixed axially as described below.

Once the output member 16 displaces an axial distance d_{A} (FIG. 4D) sufficient to disengage the output member retention surface 22 from the clutch stop surface 20 (see FIG. 3B), the input member 12 will continue to push the output member 16 (i.e., through the transfer member(s) 50) to angularly displace about the central axis A_{C}, thereby rotating the driven member 1. However, once the input member 12 stops rotating, the biasing member 30 will bias or push the output member 16 in the second axial direction D₂ toward the input and clutch members 12, 14, until the output member retention surface 22 reengages with the clutch member stop surface 20, as described above. Also, the movement of the output member 16 toward the input member 12 causes each transfer member 50 to be pushed from the curved section 56 of the drive surface 18 and onto the drive surface central section 54. Although described and depicted for angular displacement of the input member 12 in the first direction R₁, the input member 12 may drive the output member 16 (and thus the driven member 1) to rotate in a second, opposing direction R₂ in a substantially similar manner.

Referring to FIGS. 12 and 13, in the alternative construction of the drive assembly 10, each of the two section, angled drive surfaces 18 is preferably provided by a generally V-shaped notch 64 extending axially from a radial end surface of the preferred tubular body (described below) and radially completely through the body, such that the notches 64 are “open”. The input member 12 preferably includes a facing end surface 77 with a plurality of open, V-shaped notches 66, each input member notch 66 being generally aligned with a separate one of the output member notches 64. Further, each one of the transfer members 50 is partially disposed within a separate one of the output member notches 64, so as to be displaceable along the associated drive surface 18, and simultaneously partially disposed within the aligned input member notch 66. Furthermore, as the aligned pairs of notches 64, 66 are open, the alternative construction drive assembly 10 preferably includes a disk-shaped cage 68 with a plurality of holes 69. The cage 68 is disposed between the input and output members 12, 16 and each transfer member 50 is disposed within a separate hole 69 of the cage 68 to retain the members 50 within the notch pairs 64, 66.

Referring specifically to FIGS. 13A and 13B, the alternative construction of the drive assembly 10 functions generally similarly to the preferred construction as the described above, with the following differences. When the drive assembly 10 is in a static state, each transfer member 50 will be located in the central section 56 at the intersection of the two angled surface sections 57, as shown in FIG. 13A. When the input member 12 begins to rotate, for example in a first angular direction R₁ as shown in FIG. 13B, the input member 12 angularly displaces relative to the output member 16 while pushing each transfer member 50 to roll or/and slide toward one circumferential end 54 of the drive surface 18 within the particular output member notch 64. As transfer member 50 displaces along the angled surface section 57 of the drive surface 18, the output member 16 is pushed axially in a first, outwardly direction D₁ away from the input member 12, as shown in FIG. 13B. Once the mating radial retention surfaces 47, 48 are disengaged, the input member 12 will continue to push the output member 16, through the transfer member(s) 50, to angularly displace about the central axis A_{C}, thereby rotating the driven member 1. When the input member 12 stops rotating, the biasing member 30 will bias or push the output member 16 in the second axial direction D₂ toward the input and clutch members 12, 14, until the output member retention surface 22 reengages with the clutch member stop surface 20, as described above. Simultaneously, the movement of the output member 16 toward the input member 12 causes each transfer member 50 to be pushed from proximal to one end 54 back to the central section 56.

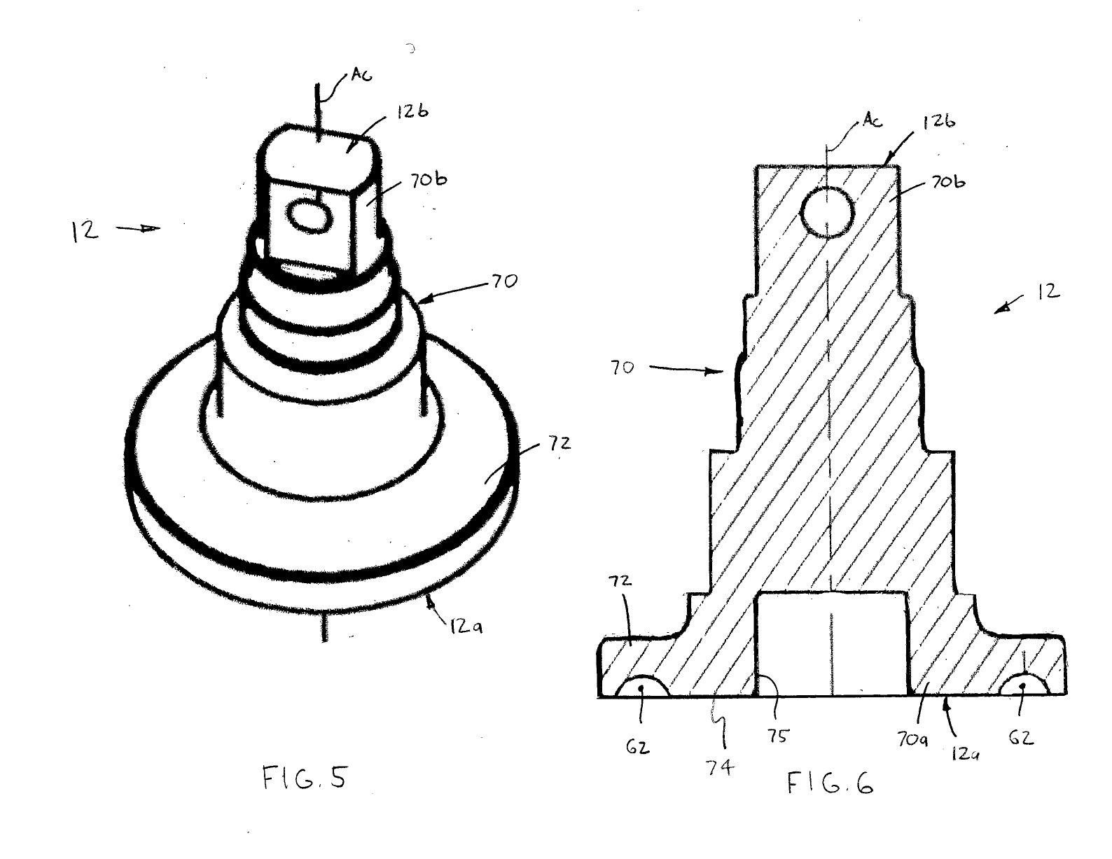

Referring to FIGS. 5 and 6, the input member 12 preferably includes a generally elongated cylindrical body 70 with opposing inner and outer ends 70a, 70b and an annular flange 72 at the inner end 70b. The flange 72 provides a generally annular radial end surface 74, the transfer member cavities 62 being formed in the end surface 74 as described above. Further, the body 70 has a central circular pocket 75 extending inwardly from the inner end 70a and is configured to receive an end of the driven member 1, as described below. Furthermore, the outer end 70b is preferably configured to mount a handle 13 (see FIG. 1). Preferably, the cylindrical body 70 is rotatably supported within the preferred housing member 40 by a bearing 15, most preferably a double-row ball bearing, disposed within the housing bore 42 such that the input member 12 is rotatable, but axially fixed. In the alternative construction shown in FIGS. 11 and 12, the input member 12 includes a generally circular tubular body 76 having an annular radial surface 77 at the inner end 76a, the notches 66 being formed in the surface 77, and radial wall 78 at the outer end 76b.

Referring to FIGS. 1, 8 and 9, as discussed above, the output member 16 preferably includes a generally circular cylindrical body 80 having inner and outer axial ends 80a, 80b and providing the tapering outer circumferential surface 17, as described above. The body 80 has a radial end surface 82, the transfer member cavities 60 extending inwardly therefrom as discussed above, and a central bore 84 extending between the body axial ends 80a, 80b. The bore 84 is configured to receive the coupler portion 2 of the driven member 1, as discussed above, such that the cylindrical body 80 is axially displaceable along the driven member portion 2. Specifically, the bore 84 and the coupler portion 2 each have aligned axial slots 86, 87 and a key 88 is disposed within each pair of slots 86, 87 so as to permit axial displacement of the body 80 on the coupler portion 2 of the driven member 1, as indicated in FIG. 2. As shown in FIGS. 11 and 12, the input member 12 of the alternative construction includes a generally circular tubular body 90 having an annular radial surface 92 at an inner end 90a and radial wall 92 at an outer end 90b.

Referring specifically to FIG. 1, in a presently preferred application, the driven member 1 is a tubular connector 4 attached to a nut 5 of a ball screw actuator 6, the actuator 6 having screw 7 connected with a closure element (not shown) of a gate valve (not shown). The nut 5 is rotatable about the central axis A_{C} and the screw 7 is linearly displaceable along the axis A_{C} to move the closure element between open and closed positions. With this structure, the drive assembly 10 transmits torque to the connector 4, such that the nut 5 is rotated about the axis A_{C} to linearly displace the closure element. When pressure exerted on the closure element reaches a level that could cause back-driving of the screw 7, the nut 5 and the connector 4, the connector 4 is prevented from rotating by the engagement of the output member 16 with the clutch member 14. Thereby, the closure element is retained in a closed position (not depicted).

Although depicted and described in the application of driving a ball-screw actuator that operates a gate valve, the drive assembly 10 may be used in any other application where a rotary actuator may be “back-driven”, such as for example, a scissor jack device.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims

I claim:

1. A lockable drive assembly for transmitting torque to a driven member, the driven member being rotatable about a central axis, the drive assembly comprising:
an input member rotatable about the axis and having inner and outer axial ends;
a clutch member fixed with respect to the axis; and
an output member with inner and outer axial ends and being slidably coupled with the driven member such that the output member is displaceable along the axis relative to the driven member and angular displacement of the output member angularly displaces the driven member, the output member being releasably engageable with the clutch member so as to substantially prevent angular displacement of the output member and having at least one drive surface proximal to the inner end and extending circumferentially and axially with respect to the central axis, the input member inner end being operatively engageable with the output member drive surface such that angular displacement of the input member axially displaces the output member out of engagement with the clutch member and then angularly displaces the output member about the central axis to rotate the driven member.

2. The drive assembly as recited in claim 1 wherein engagement of the output member with the clutch member prevents angular displacement of the driven member.

3. The drive assembly as recited in claim 1 further comprising a biasing member configured to bias the output member toward the input member such that the output member engages with the clutch member.

4. The drive assembly as recited in claim 1 wherein the clutch member includes a friction surface and the output member includes a mating friction surface frictionally engageable with the clutch surface so as to prevent angular displacement of the output member.

5. The drive assembly as recited in claim 4 wherein one of:
the clutch member has an inner circumferential surface tapering axially so as to be generally conical and providing the stop surface and the output member has an outer circumferential surface tapering axially so as to be generally conical and providing the retention surface, the output member being at least partially disposeable within the clutch member such that the output member outer surface engages with the clutch member inner surface;
the clutch member has a radial surface providing the friction surface and the output member has a radial surface providing the clutch surface and being engageable axially with the clutch radial surface.

6. The drive assembly as recited in claim 1 further comprising at least one transfer member disposed between the input and output members and configured such that angular displacement of the input member pushes the transfer member against the output member drive surface such that the transfer member displaces a distance along the drive surface until the retention surface disengages from the friction surface, and then the input member pushes the output member to angularly displace about the central axis through the transfer member.

7. The drive assembly as recited in claim 6 wherein the transfer member includes a spherical body.

8. The drive assembly as recited in claim 6 wherein the output member includes a plurality of drive surfaces spaced circumferentially about the central axis, and the at least one transfer member includes a plurality of the transfer members each disposed against a separate one of the drive surfaces.

9. The drive assembly as recited in claim 6 wherein:
the output member has a generally cylindrical body with opposing, first and second ends spaced apart along the axis, the first end being at least generally adjacent to the input member;
the drive surface has two opposing ends located at the body first end and a central section spaced axially from the body first end; and
the output member displaces axially when the input member forces the transfer member to displace generally from the drive surface central portion and towards one of the drive surface ends.

10. The drive assembly as recited in claim 9 wherein one of:
the drive surface is formed as a generally continuous surface further having two opposing curved sections each extending between the central section and a separate one of the surface ends; and
the drive surface is formed of two generally flat, angled surface sections each extending from a separate one of the surface ends and generally converging at the surface central section.

11. The drive assembly as recited in claim 9 further comprising a biasing member configured to bias the output member generally toward the clutch member such that output member retainer engages with the clutch member stop while the transfer member displaces generally toward the drive surface central section.

12. The drive assembly as recited in claim 9 wherein the output member has a radial end surface at the first end and at least one elongated cavity extending axially from the end surface and partially circumferentially about the central axis, the cavity being at least partially defined by the at least one drive surface.

13. The drive assembly as recited in claim 12 wherein the input member includes a radial end surface, the end surface generally facing and spaced axially from the output member end surface, and at least one cavity extending axially from the end surface and partially circumferentially about the central axis, the at least one input member cavity being generally aligned with the at least one output member cavity and the at least one transfer member being partially disposed within each of the aligned input and output member cavities.

14. The drive assembly as recited in claim 1 wherein the clutch member is provided by a generally tubular housing having opposing ends and a central bore extending between the ends, the input and output member being disposed at least partially within the bore and the stop being provided by an inner circumferential surface section at least partially defining the housing bore.

15. The drive assembly as recited in claim 1 wherein the output member includes a generally cylindrical body having opposing axial ends and a central bore extending between the two axial ends, the drive surface being formed generally at one of the two axial ends and the bore being configured to receive a portion of the driven member such that the cylindrical body is axially displaceable along the driven member portion.

16. A rotary actuator comprising:
a ball screw assembly including a screw and a nut, the nut being rotatable about a central axis and the screw being linearly displaceable along the axis; and
a lockable drive assembly configured to transmit torque to the nut and including:
an input member rotatable about the axis and having inner and outer axial ends;
a clutch member fixed with respect to the axis; and
an output member with inner and outer axial ends and being slidably coupled with the nut such that the output member is displaceable along the axis relative to the nut and angular displacement of the output member angularly displaces the nut, the output member being releasably engageable with the clutch member so as to substantially prevent angular displacement of the output member and having at least one drive surface proximal to the inner end and extending circumferentially and axially with respect to the central axis, the input member inner end being operatively engageable with the output member drive surface such that angular displacement of the input member axially displaces the output member out of engagement with the clutch member and then angularly displaces the output member about the central axis to rotate the nut.

17. The rotary actuator as recited in claim 1 further comprising a generally tubular connector having a first end connected with the nut and a second end with a coupler portion, the output member being slidably disposed on the connector coupler portion so as to slidably couple the output member with the nut.

18. A lockable drive assembly for transmitting torque to a driven member, the driven member being rotatable about a central axis, the clutch assembly comprising:
a rotatable input member;
a static clutch member having a stop surface;
an output member slidably coupled with the driven member so as to be linearly displaceable along the axis relative to the driven member, the output member having a retention surface engageable with the clutch stop surface so as to substantially prevent angular displacement of the output member and at least one drive surface extending circumferentially and axially, the input member being operatively engageable with the output member drive surface such that angular displacement of the input member axially displaces the output member out of engagement with the friction surface and then angularly displaces the output member about the central axis to angularly displace the driven member.
